(19) United States
(12) Patent Application Publication
(10) Pub. No.: US 2005/0005170 A1
(43) Pub. Date: Jan. 6, 2005

(54) Minimizing information gathered by access decision engines in access control systems

(75) Inventors: Jan Camenisch, Rueschlikon (CH); Michael Waidner, Au (CH)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 10/874,431

(22) Filed: Jun. 23, 2004

(30) Foreign Application Priority Data
Jun. 26, 2003 (EP) 03405469.2

(51) Int. Cl. G06F 11/30; H04L 9/32

(52) U.S. Cl. 713/201

(57) ABSTRACT

Provides efficient schemes that allow a user to decide what information an access granting party gets to know. This enables the user to control and minimize information conveyed. It provides methods, apparatus and systems for verifying and enabling access to a service. An example of a method comprises the steps of: receiving a request from a remote computer requesting access to the service computer providing the service desired by a user; sending to the remote computer a response comprising an access policy, the access policy describing at least one possibility to obtain access to the service computer; receiving from the remote computer a reply comprising a description of evidence information to be gathered to fulfill the access policy; receiving evidence information specified by the description; and in the event that the received evidence information is sufficient to fulfill the access policy enabling the access, otherwise denying the access.

### TECHNICAL FIELD

The present invention relates to verifying and enabling access to a service provided by a service computer.

### BACKGROUND OF THE INVENTION

More and more services within networks request certain access-rights in order to grant access. Access-rights to resources are often described as logical expression over users' attributes which is also referred to as access rule. An example of such a “rule” is: “the user must either be over eighteen or must have consent from her parents”. In case the attributes need not to be certified, they can be provided directly by the user; otherwise they need to be provided by a third parties (e.g., Microsoft's passport), or by using attribute certificates.

Today's access decision engines determine whether or not a user is granted access to some resource by first collecting all attributes appearing in the access rule and then by evaluation the rule. This approach has the drawback that the access decision or granting engine gets to know all data about the user. The users are concerned about their privacy and information released to the access decision engines which lack strong privacy mechanisms.

From the above it follows that there is need in the art to minimize the information that can be gathered by access decision engines or computers within a network. In fact, the user should be able to decide which attributes or information an access granting party should get to know and hence to minimize the information conveyed.

### SUMMARY AND ADVANTAGES OF THE INVENTION

Therefore, the present invention provides efficient schemes that allows a user to decide which attributes or information an access granting party, hereafter also referred to as access decision engine, gets to know. Therewith it is in the hands of the user to minimize the information conveyed.

In accordance with a first aspect of the present invention, there is given a method for verifying and enabling access to a service S provided by a service computer. The method comprises the steps of: receiving a request from a remote computer requesting access to the service that is desired by a user; sending to the remote computer a response comprising an access policy AP for accessing the service, the access policy AP describing at least one possibility to obtain access to the service; receiving from the remote computer a reply comprising a description of evidence information DEI to be gathered to fulfill the access policy AP; receiving evidence information EI specified by the description DEI; and in the event that the received evidence information EI is sufficient to fulfill the access policy AP enabling the access, otherwise denying the access.

### DESCRIPTION OF THE DRAWINGS

Embodiments of the invention are described in detail below, by way of example only, with reference to the following schematic drawings.

FIG. 1 shows a schematic setup with information flow between a user's remote computer, an access decision engine, and a service computer providing a service.

FIG. 2 shows a schematic setup in which evidence information is provided by an information service computer to a unity comprising the access decision engine and the service computer.

FIG. 3 shows a schematic setup with another information flow.

FIG. 4 shows a schematic setup in which further evidence information is provided to the access decision engine by a further information service computer.

FIG. 5 shows a schematic setup in which an access granting token AGT for use with a further service computer is involved.

FIG. 6 shows a schematic setup in which authentication is involved.

### DESCRIPTION OF THE INVENTION

The present invention provides efficient schemes that allows a user to decide which attributes or information an access granting party, hereafter also referred to as access decision engine, gets to know. Therewith it is in the hands of the user to minimize the information conveyed. The following describes from the user's view how access to a service can be obtained and granted that gives the user the choice which evidence is to get known to an access decision engine. At first, the user asks or requests to access a service. Then, the access decision engine checks whether the user has already provided evidence that he or she is allowed to access the service. If yes, access is granted. In the other case, it is continued with the next steps.

The access decision engine informs with a reply the user what evidence, e.g., credentials, statement by third parties, or the like, needs to be provided to get access and possibly what evidence the user has already provided, i.e., the user is send an access condition or access policy. The user reviews what evidence is required and decides which evidence he or she wants to provide, for example, which credentials he or she wants to show, or which parties or servers the access decision engine should ask for evidence. This has the advantage that the user can decide which evidence he or she wants to provide the access decision engine in order to get access. It is advantageous if the access condition or policy is displayed to the user. In a further example, the user can gather related evidence from third parties. This can involve getting credentials/certificates that the user would forward to the access decision engine or inquiring with third parties that would possibly later be queried for evidence by the access decision engine. Moreover, the user can collect further evidence, e.g., credentials. Then, the user let the access decision engine know which evidence he or she wants to be gathered by the decision engine. This might include the user sending authorization tokens to the access decision engine so as to enable the latter to request evidence from third parties.

Accordingly, the access decision engine gathers the evidence, either from the user directly or from third parties. This can include that the user provides the evidence, for example, by proving possession of credentials, without the access decision engine getting to know which particular evidence allows the user the access. For instance, the user proves that he or she is either 18 or has consent from her parents as opposed to just sending a certificate that states that he or she is over 18. Finally, if all evidence can be retrieved, the access decision engine grants the access.

In accordance with a first example embodiment of the present invention, there is given a method for verifying and enabling access to a service S provided by a service computer. The method comprises the steps of: a) receiving a request from a remote computer requesting access to the service that is desired by a user; b) sending to the remote computer a response comprising an access policy AP for accessing the service, the access policy AP describing at least one possibility to obtain access to the service; c) receiving from the remote computer a reply comprising a description of evidence information DEI to be gathered to fulfill the access policy AP; d) receiving evidence information EI specified by the description DEI; and e) in the event that the received evidence information EI is sufficient to fulfill the access policy AP enabling the access, otherwise denying the access.

An advantage of this method is that the user has the full control about the information he or she is willing to reveal. The user can define what information about him/her is available to and can be collected by an access control system. This leads to more privacy with access control systems, because the information gathered by the access decision engine is minimized. The remote computer can send the evidence information EI or part of it directly to the access granting engine. By doing so, the access process is simplified because the access granting engine does not need to request the evidence information from, e.g., the remote computer or any other information server.

It appears to be advantageous when the access granting engine and the service computer form a unit, because then the communication can be reduced between the access granting engine and the service computer, leading to a faster access. This also avoids communication over the network.

Step d), receiving evidence information EI, can further comprise receiving identifying information II from the user allowing to obtain further evidence information FEI about the user from an information service computer. This allows the access granting engine to obtain the evidence information EI or part thereof from third parties or other data sources. Step e), enabling the access, can further comprise issuing an access granting token AGT for use with a further service computer. This allows the user to control to whom it is allowed to request identifying information II from further service computers. Step c) receiving from the remote computer a reply, can be omitted, and step d) receiving evidence information EI, can either include the description of the evidence information DEI or the description of the evidence information DEI is implicit from the sent/received evidence information EI. That is, in the latter case the sent evidence information EI implicitly states the user's consent of what is to be gathered to fulfill the access policy AP. Since the user does not need to send explicitly what he or she is willing to reveal, the process becomes more efficient.

Desired privacy criteria are much better fulfilled when the access policy AP is displayed to the user who then can actively select the information to be revealed. Thereby, the user is well informed and can interactively choose the information he or she is willing to disclose.

When steps a) and b) are omitted and in step c) the access policy AP and/or the description of evidence information DEI are/is received, then the present invention can be implemented into current systems in a much simpler manner, e.g., with browser-based access.

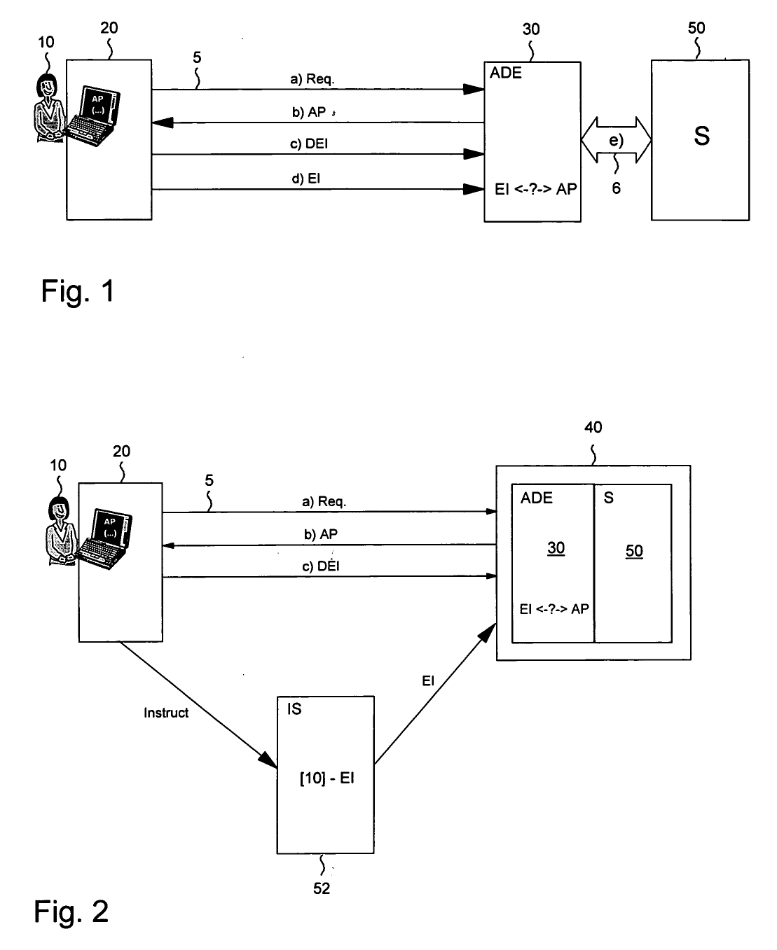

In the following various embodiments are described. The same reference signs or numbers are used to denote the same parts or the like. FIG. 1 shows a basic scenario that allows a user 10 with its remote computer 20 to access via an access decision engine 30, also labeled with ADE, a service that is provided by a service computer 50, also labeled with S; For the sake of simplicity, only one such service S is depicted in the figure. The figure further illustrates the general flow of information within messages for which arrows 5 are labeled accordingly. The information within the messages are usually transported via a network that can be the Internet or a local network. The remote computer 20 can be any device suitable to perform actions and connect to a network, such as a computer, a handheld device, a mobile phone etc.. In the following it is assumed that the user 10 is connected to the access decision engine 30 that can be implemented by a server. The access decision engine 30 can be further connected to the service computer 50 which usually is a server of a service provider providing the service S. The flow of messages in the figures is indicated by arrows, labeled with lower case letters a) to e) and abbreviations, like Req., AP, DEI, EI, II, or FEI, indicating the content or information of the respective message. In operation, the user 10 desiring the service S sends a request message a) comprising a request, hereafter also referred to as request a), from its remote computer 20 to the access decision engine 30 requesting access to the service computer 50. In response to the request a) the access decision engine 30 sends to the remote computer 20 a response message comprising an access policy AP which is necessary for accessing the service S of the service computer 50. The response message is hereafter also referred to as response b). The access policy AP describes at least one possibility to obtain access to the service S of the service computer 50. Thereupon, the user 10 receives the access policy AP and can displayed it, as indicated by AP ( . . . ) in the figure. Now the user 10 can actively select the information or personal data he or she is willing to reveal. A reply message, hereafter referred to as reply c), from the user 10 to the access decision engine 30 comprises a description of evidence information DEI which is allowed to be gathered to fulfill the access policy AP. The access decision engine 30 further receives in an evidence receiving message, hereafter referred to as message d), evidence information EI about the user 10 specified by the description DEI. Finally, in the event that the received evidence information EI is sufficient to fulfill the access policy AP, the access decision engine 30 enables e) the access 6 to the service computer 50. In case the evidence information EI is not sufficient to fulfill the access policy AP the access 6 is denied. The verification whether or not the evidence information EI is sufficient to fulfill the access policy AP is indicated in the figure by EI<-?->AP.

FIG. 2 shows a schematic flow and setup in which evidence information EI is sent from an information service computer 52 to a unity 40 comprising the access decision engine 30 and the service computer 50. Here the access decision engine 30 and the service computer 50 form a single unity 40 in order to provide faster access for the user 10. The information service computer 52 that is a separate information server within the network stores evidence information EI of the user 10, illustrated by [10]-EI. As FIG. 2 shows, the user 20 with its remote computer 20 instructs with an Instruct message the information service computer 52 to deliver the stored evidence information EI to the access decision engine 30 within the unity 40. This might be advantageous when the user 10 has already a so-called user profile setup and is using it with various services.

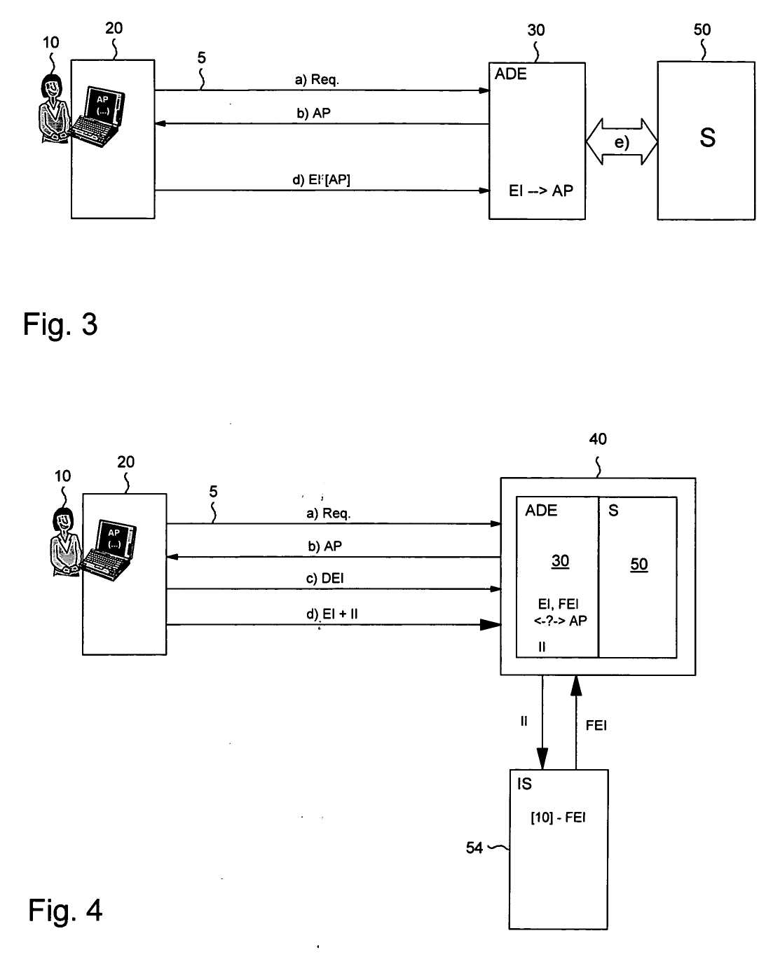

FIG. 3 shows the schematic setup similar to FIG. 1 with another information flow in which the remote computer 20 sends the evidence information EI fulfilling the access policy AP directly to the access decision engine 30 without having sent the reply c) with the description of the evidence information DEI. The sent evidence information EI comprises information that implicitly states the user's consent of what is to be gathered by the access decision engine 30 to fulfill the access policy AP.

FIG. 4 shows a further schematic setup in which further evidence information FEI is provided to the access decision engine 30 within the unity 40 by a further information service computer 54. The further evidence information FEI of the user 10, illustrated by [10]-FEI, is stored by the further information service computer 54. In operation, the access decision engine 30 receives with the message d) the evidence information EI and identifying information II from the user 10. This identifying information II allows the access decision engine 30 to obtain the further evidence information FEI about the user 10 from the further information service computer 54, as indicated in the FIG. 4. The verification whether or not the evidence information EI and/or the further evidence information FEI are/is sufficient to fulfill the access policy AP is illustrated in the figure by EI, FEI<-?->AP.

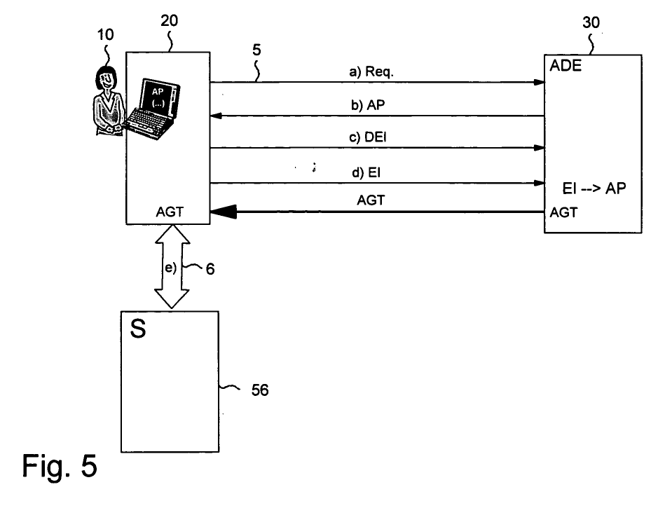

FIG. 5 shows another schematic setup in which an access granting token AGT for use with a further service computer 56 is involved. The further service computer 56 provides the service that the user 10 is interested in. As indicated in FIG. 5, the access decision engine 30 issues the access granting token AGT after having received the message d) with the evidence information EI and having verified the evidence information EI to fulfill the access policy AP. The access granting token AGT is sent to the user's remote computer 20, which than can be used to access 6 the further service computer 56 within the network.

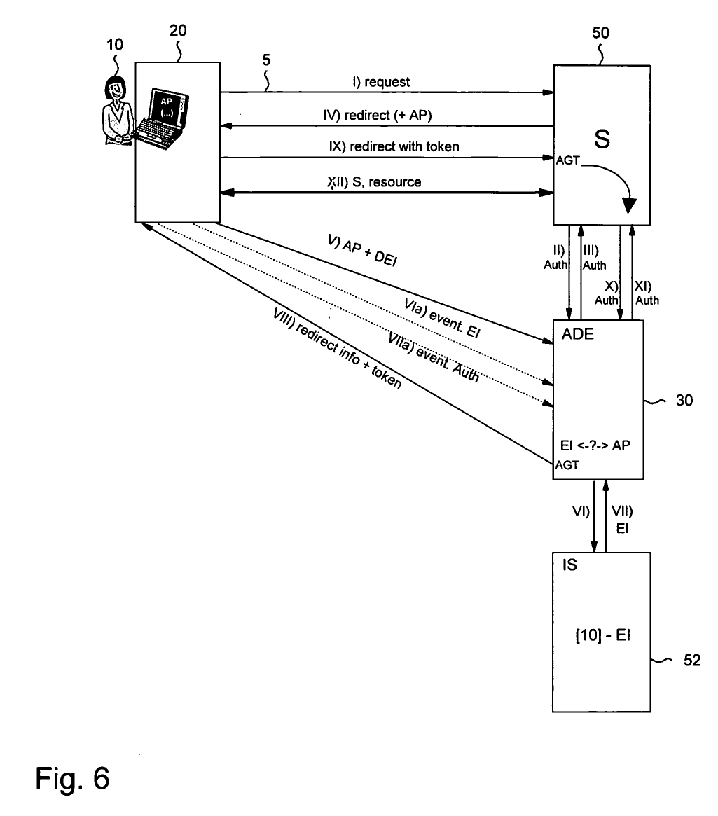

FIG. 6 shows yet another schematic setup and flow in which authentication and a token, like the access granting token AGT, are involved. The flow of the messages is indicated with Roman numbers in order to understand the chronological order of the messages within the system. At first, message I) comprises a request for accessing the service S and its recourses. This message I) is sent from the user's remote computer 20 to the service computer 50. It follows an authentication process between the service computer 50 and the access decision engine 30 supported by the messages II) and III). The service computer 50 sends then message IV) with a redirect information and the access policy AP to the remote computer 20. The user 10 makes a selection to the access policy AP and sends the access policy AP and the description of evidence information DEI within message V) to the access decision engine 30. The access decision engine 30 connects to the information service computer 52 to receive the evidence information EI, as indicated with messages VI) and VII). Alternatively, as indicated with the dotted arrows, message VIa) from the remote computer 20 to the access decision engine 30 can already comprise the evidence information EI and message VIIa) an authentication information. With message VIII) is sent from the access decision engine 30 to the remote computer 20 a redirect information and the token with which access to the desired service S can be obtained. The redirect information is then used by the remote computer 20 to connect to the right service computer 50 that here is the same which was contacted initially with message I), but could also be a different service computer. As indicated with message IX) the token is then sent with a redirect or further request to the service computer 50, which then further performs with messages X) and XI) a further authentication based on the received token. If the token is valid, the service computer 50 provides its service S and resource to the remote computer 20 as indicated with message XII).

Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Any disclosed embodiment may be combined with one or several of the other embodiments shown and/or described. This is also possible for one or more features of the embodiments. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. A method for verifying and enabling access to a service provided by a service computer comprising the steps of:
a) receiving a request from a remote computer requesting access to the service computer providing the service desired by a user;
b) sending to the remote computer a response comprising an access policy, the access policy describing at least one possibility to obtain access to the service computer;
c) receiving from the remote computer a reply comprising a description of evidence information to be gathered to fulfill the access policy;
d) receiving evidence information specified by the description; and
e) enabling the access if the received evidence information is sufficient to fulfill the access policy, otherwise denying the access.

2. The method according to claim 1, wherein the remote computer sends the evidence information directly to an access decision engine.

3. The method according to claim 2, wherein the access decision engine and the service computer form a unity.

4. The method according to claim 1, wherein the step d) of receiving evidence information further comprises receiving identifying information from the user allowing to obtain further evidence information about the user from an information service computer.

5. The method according to claim 1, wherein the step of enabling the access further comprises issuing an access granting token for use with a further service computer.

6. The method according to claim 1, wherein the step c) of receiving from the remote computer a reply is omitted and the step d) of receiving evidence information comprises evidence information that implicitly states the user's consent of what is to be gathered to fulfill the access policy.

7. The method according to claim 1, wherein the access policy is displayed to the user who then actively selects information to be revealed.

8. The method according to claim 1, without the steps a) and b), thereby receiving in step c) the access policy and/or the description of evidence information.

9. A program storage device readable by machine, tangibly embodying a program of instructions executable by the machine to perform method steps for verifying and enabling access to a service provided by a service computer, said method steps comprising the steps of claim 1.

10. An article of manufacture comprising a computer usable medium having computer readable program code means embodied therein for causing verification and enablement of access to a service provided by a service computer, the computer readable program code means in said article of manufacture comprising computer readable program code means for causing a computer to effect the steps of:
receiving a request from a remote computer requesting access to the service computer providing the service desired by a user;
sending to the remote computer a response comprising an access policy, the access policy describing at least one possibility to obtain access to the service computer;
receiving from the remote computer a reply comprising a description of evidence information to be gathered to fulfill the access policy;
receiving evidence information specified by the description; and
enabling the access if the received evidence information is sufficient to fulfill the access policy, otherwise denying the access.

11. An apparatus to verify and enable access to a service provided by a service computer comprising:
a) means for receiving a request from a remote computer requesting access to the service computer providing the service desired by a user;
b) means for sending to the remote computer a response comprising an access policy, the access policy describing at least one possibility to obtain access to the service computer;
c) means for receiving from the remote computer a reply comprising a description of evidence information to be gathered to fulfill the access policy;
d) means for receiving evidence information specified by the description; and
e) means for enabling the access if the received evidence information is sufficient to fulfill the access policy, otherwise denying the access.

12. A computer program product comprising a computer usable medium having computer readable program code means embodied therein for causing verification and enablement of access to a service provided by a service computer, the computer readable program code means in said computer program product comprising computer readable program code means for causing a computer to effect the functions of:
means for receiving a request from a remote computer requesting access to the service computer providing the service desired by a user;
means for sending to the remote computer a response comprising an access policy, the access policy describing at least one possibility to obtain access to the service computer;
means for receiving from the remote computer a reply comprising a description of evidence information to be gathered to fulfill the access policy;
means for receiving evidence information specified by the description; and
means for enabling the access if the received evidence information is sufficient to fulfill the access policy, otherwise denying the access.

13. A computer device within an access control system comprising:
a computer program product according to claim 11; and
a processor for executing the computer program product when the computer program product is run on the computer device.

14. The method according to claim 2, wherein the step d) of receiving evidence information, further comprises receiving identifying information from the user allowing to obtain further evidence information about the user from an information service computer.

15. The method according to claim 2, wherein the step of enabling the access further comprises issuing an access granting token for use with a further service computer.

16. The method according to claim 2, wherein the step c) of receiving from the remote computer a reply is omitted and the step d) of receiving evidence information comprises evidence information that implicitly states the user's consent of what is to be gathered to fulfill the access policy.

17. The method according to claim 3, wherein the step d) of receiving evidence information further comprises receiving identifying information from the user allowing to obtain further evidence information the user from an information service computer.

18. The method according to claim 3, wherein the step of enabling the access further comprises issuing an access granting token for use with a further service computer.

19. The method according to claim 3, wherein the step c) of receiving from the remote computer a reply is omitted and the step d) of receiving evidence information comprises evidence information that implicitly states the user's consent of what is to be gathered to fulfill the access policy.

20. The method according to claim 2, wherein the access policy is displayed to the user who then actively selects information to be revealed.

21. The method according to claim 3, wherein the access policy is displayed to the user who then actively selects information to be revealed.
